(19) United States
(12) Patent Application Publication
(10) Pub. No.: US 2024/0305149 A1
(43) Pub. Date: Sep. 12, 2024

(54) STATOR WITH PERMANENT PROTECTIVE BARRIER SEALING

(71) Applicant: Elaphe Propulsion Technologies, Ltd., Ljubljana (SI)

(72) Inventors: Joze Buh, Ljubljana (SI); Matija Luetic, Celje (SI); Slavko Palackovic, Ljubljana-Sentvid (SI); Borut Obrul, Smartno pri Litiji (SI); Gasper Sustersic, Ljubljana-Sentvid (SI)

(21) Appl. No.: 18/688,206

(22) PCT Filed: Aug. 24, 2022
(86) PCT No.: PCT/EP2022/073579

§ 371 Date: Feb. 29, 2024

(30) Foreign Application Priority Data
Aug. 31, 2021 (DE) 102021122453.5

(51) Int. Cl. H02K 1/18; H02K 3/44; H02K 15/02; H02K 15/12

(52) U.S. Cl. CPC H02K 1/187; H02K 3/44; H02K 15/026; H02K 15/12

(57) ABSTRACT

The present invention concerns a stator for an electric machine of the type that comprises a stator, a rotor and an air gap in-between, in particular an inner stator for an outer rotor motor; the stator comprising a stator core having a plurality of core teeth, electromagnetic windings arranged around the core teeth, a stator housing comprising a recessed space which is open at the air gap-facing side of the stator, the recessed space accommodating the stator core and the electromagnetic windings, and a water impermeable protective barrier sealing the recessed space at the open air gap-facing side in a fluid-tight manner, characterized in that the protective barrier is permanently bonded to the windings and the core teeth by potting material provided in the recessed space. The present invention further relates to a corresponding method of manufacturing as well as to the use of an air gap-facing protective barrier of a stator as a potting material barrier structure.

The present invention relates to a stator for an electric machine of the type that comprises a stator, a rotor and an air gap in-between according to the independent device claim. In particular the present invention relates to an inner stator for an outer rotor motor, for example to an ‘in-wheel’ motor for an automobile. The present invention also relates to the manufacturing of a stator of the aforementioned type according to the related independent method claim and to the use of an air gap-facing protective barrier of a stator as a potting material barrier structure according to the independent use claim.

The prior art document US 2013/0020885 A1 discloses an encapsulated stator including a driving module coupled to a shaft tube. The driving module includes a silicon steel plate unit. A coil unit is wound around the silicon steel plate unit. A jacket is mounted to an outer periphery of the silicon steel plate unit of the driving module. The jacket includes an inner face and an outer face opposite to the inner face. The inner face of the jacket faces the driving module. An encapsulant is bonded to the driving module, the jacket, and the shaft tube. The encapsulant encapsulates the driving module. The encapsulant partially encapsulates the outer face of the jacket. The manufacturing process in connection with this arrangement of the encapsulant and the jacket and its proper assembly with the other stator parts is comparably work-intensive.

The prior art document U.S. Pat. No. 8,421,297 B2 discloses an electric machine having an outer stator and an inner rotor and an air-gap in-between. The stator is protected from exposure to heat transfer fluids, process fluids, other corrosive or harmful matter and/or other foreign matter by a protective barrier. Again, the manufacturing process in connection with this protective barrier and its proper assembly with the other stator parts is comparably work-intensive.

The present invention has the objective to provide a reliable protection of a stator of the initially mentioned type, in particular of the electromagnetic windings and stator core teeth of the stator, against ingress of moisture, dust, salt, roadside chemicals and other harmful influences coming from the air gap, while at the same time enabling a time and cost-efficient manufacturing process of the stator. It is a further objective to increase the reliability and manufacturing efficiency of electric machines of the aforementioned type.

The present invention suggests achieving the aforementioned objective by a stator according to the independent device claim 1.

The present invention suggests a stator for an electric machine of the type that comprises a stator, a rotor and an air gap in-between, in particular an inner stator for an outer rotor motor; the stator comprising a stator core having a plurality of core teeth, electromagnetic windings arranged around the core teeth, a stator housing comprising a recessed space which is open at the air gap-facing side of the stator, the recessed space accommodating the stator core and the electromagnetic windings, and a water impermeable protective barrier sealing the recessed space at the open air gap-facing side in a fluid-tight manner, characterized in that the protective barrier is permanently bonded to the windings and the core teeth by potting material provided in the recessed space.

By the protective barrier being permanently bonded to the windings and the core teeth by cured potting material provided in the recessed space, the protective barrier is reliably connected to the stator windings and the stator core teeth and structural strength is provided to the stator and its parts, while at the same time the windings and core teeth are protected from corrosive influences from the air gap and ingress of water even in the case that the protective barrier is breached and a time-efficient manufacturing and stator assembly process is made possible.

In a possible embodiment, a bond-increasing mesh-like material permeated by the potting material is provided between the core teeth and the protective barrier.

The bond-increasing material further increases the structural strength and integrity of the stator, in particular the crack resistance of the cured and rigid potting material, and at the same time serves as a kind of thin spacer between the protective barrier and the core teeth that can be soaked through by the liquid potting material during the potting process and thus can ensure that the liquid potting material properly reaches and bonds with all areas of the protective barrier and of the core teeth and also, for example, of the windings.

In a further possible embodiment, the bond-increasing material is made from a flexible sheet material, more particularly the bond-increasing material comprises at least one filament containing roving layer and/or a steel mesh.

The use of a flexible sheet material as the bond-increasing material facilitates the manufacturing process as the positioning and shape of bond-increasing material can be adapted to the outer shape of the stator windings and the stator core teeth.

In a further optional embodiment, the bond-increasing material comprises at least one filament containing roving layer and/or a steel mesh.

The use of filament containing roving layers and/or of a steel mesh allows for a reliable permeation of the bond-increasing material with the liquid potting material during the potting process, while at the same time providing the later stator with improved crack-resistance properties.

In a further possible embodiment, the at least one filament containing roving layer comprises at least one of the following components: glass fibers and carbon fibers.

A glass fiber roving layer and/or a carbon fiber roving layer allows for a time-efficient handling of the layer or layers that can be provided in the form of plies. In one particular embodiment, two plies of glass roving are provided between the core teeth and the protective barrier.

In another possible embodiment, the bond-increasing material envelops the windings and the core teeth on at least one of the two axial sides and on a radial side with respect to the axis of rotation of the electric machine.

This arrangement of the bond-increasing material enables an improved bonding of the protective barrier to the windings and core teeth and at the same time supports the potting material during the potting process in contacting the windings and core teeth at these sides.

In a preferred embodiment, the stator is an inner stator and the bond-increasing material envelopes the windings and the core teeth on the two axial sides and on the radial outer side.

It is also possible that in a further embodiment, the protective barrier is made from a flexible sleeve and/or is at least partly transparent.

When the protective barrier is made from a flexible sleeve, it can cover and seal the recessed space in a time-efficient manner by pulling the sleeve over the recessed space during the manufacturing process.

In an optional embodiment, the protective barrier is at least partly transparent. This allows for a time-efficient and easy visual inspection of whether the protective barrier has bonded to the windings and the core teeth in the desired manner.

In yet another embodiment, the protective barrier is made from a polymer sheet material, in particular from a heat shrinkable polymer sheet material and/or from an elastic polymer sheet material, or is made from a stainless steel sheet material.

Using a polymer sheet material for the protective barrier allows for an easy handling of the protective barrier during the manufacturing process.

In particular embodiments, the polymer sheet material is made from a heat shrinkable material and/or an elastic sheet material. This allows, in an easy and reliable manner, to tightly cover the recessed space with the protective barrier which facilitates the potting and bonding process and improves the assembly in a watertight manner.

In cases in which the protective barrier is made from a stainless steel sheet material, the protective layer not only comprises excellent corrosive resistant properties, but also excellent impact resistance. When using stainless steel sheet material, the issue of possible eddy currents losses is appropriately taken into account and dealt with according to common practice.

In a preferred optional embodiment, the protective barrier seals the recessed space at the open air gap facing-side by other means than the potting material, in particular by an adhesive.

This allows an improved and time-efficient manufacturing process as the protective barrier can seal the recessed space prior to the potting process, so that the potting material can be introduced into the predefined and sealed recessed space, wherein the protective barrier prevents the liquid potting material from leaking out of the recessed space and, for example, from coming into contact with a supportive potting mould wall. This increases the lifetime when using reusable potting moulds.

Optionally using an adhesive to seal the recessed space with the protective barrier, for example by gluing the areas where the protective barrier contacts the stator housing that surrounds the recessed space to the stator housing, is an efficient way of sealing the recessed space.

In another embodiment, the protective barrier contacts the stator housing at opposing axial outer walls of the stator housing, the outer walls have the recessed space in-between and the protective barrier is joined to the outer walls in a fluid-tight manner.

In this arrangement the protective barrier can span the recessed space in the axial direction from one outer wall to the other outer wall. Further, by joining the protective barrier in a fluid-tight manner to the outer walls, the recessed space can be sealed prior to the introduction of the liquid potting material during the manufacturing process and the fluid-tight joining process of the protective barrier to the outer walls takes place at the easy accessible axial outer walls of the housing.

In a further possible embodiment, the protective barrier at least partly comprises an adhesive bond increasing surface finish, in particular a roughened surface finish, on the side facing the stator housing and/or the stator housing at least partly comprises an adhesive bond increasing surface finish, in particular a roughened surface finish on the side facing the protective barrier.

The bond increasing surface finishes help to increase the reliable bonding of the prepared sur-faces to the potting material or to an additional adhesive.

The optional roughened surface finishes, for example realized by a TCA (tri-chloric acid) treatment in the case of a polymeric protective barrier sheet being used or by a KTL (‘Kathodische Tauchlackierung’) coating in the case of a stator housing being made of aluminum is used, further improves the reliable bonding of roughened areas to the potting material or to an additional adhesive.

For example, in the case of the stator housing at least partly comprising a roughened surface finish on the side facing the protective barrier, the radial edges of the outer walls of the stator housing can be provided with a roughened surface to improve the bonding and sealing to the protective barrier at this location by use of an adhesive.

It is further possible that in another embodiment, the windings and the stator teeth are accommodated fully within the recessed space, such that the surrounding outer walls of the stator housing are of about equal height or higher than the stator teeth and windings in a radial direction with respect to the axis of rotation of the electric machine.

This arrangement provides easy to access radial areas where the protective barrier can be bonded to the stator housing to seal the recessed space.

The initially stated objective is further achieved by an electric machine of the type that comprises a stator, a rotor and an air gap in-between, in particular by an outer rotor motor, comprising a stator according to one of the aforementioned embodiments.

The objective underlying the invention is further achieved by a method according to the independent method claim 12.

The present invention suggests a method of manufacturing a stator for an electric machine of the type that comprises a stator, a rotor and an air gap in-between, in particular a method of manufacturing an inner stator for an outer rotor motor, the method comprising the steps of providing an assembly comprising a stator housing accommodating a stator core having core teeth and electromagnetic windings arranged around the core teeth in a recessed space, wherein the recessed space is open at the air gap-facing side of the stator, and providing a water impermeable protective barrier and covering the recessed space at the open side with the protective barrier, characterized by introducing liquid potting material into the covered recessed space for permanently bonding the protective barrier to the windings and the core teeth.

By introducing liquid potting material into the covered recessed space for permanently bonding the protective barrier to the windings and the core teeth, the protective barrier can be reliably connected to the stator windings and the stator core teeth and structural strength is provided to the stator and its parts, while at the same time the windings and core teeth are protected from corrosive influences and ingress of water from the air gap, even in the case that the protective barrier is breached and a time-efficient manufacturing and stator assembly process is made possible.

In a possible embodiment, the method comprises the step of sealing the recessed space at the open side with the protective barrier in a fluid-tight manner, in particular by using an adhesive, prior to introducing the potting material.

This allows an improved and time-efficient manufacturing process as the protective barrier seals the recessed space prior to the potting process, so that the potting material can be introduced into the predefined and sealed recessed space, wherein the protective barrier prevents the liquid potting material from leaking out of the recessed space and, for example, from coming into contact with a supportive potting mould wall.

In an optional embodiment, an adhesive is used as an easy and reliable way of sealing the recessed space prior to the introduction of the potting material.

In yet another embodiment, the method further comprises the step of covering the core teeth with a bond-increasing mesh-like material, in particular with flexible bond-increasing mesh-like sheet material, prior to the covering of the recessed space, in particular enveloping the windings and the core teeth on at least one of the two axial sides and on a radial side with respect to the axis of rotation of the electric machine prior to the covering of the recessed space.

The step of covering the core teeth with a bond-increasing mesh-like material further increases the later structural strength and integrity of the stator, in particular the crack resistance of the later cured and rigid potting material, and at the same time provides a kind of thin spacer between the protective barrier and the core teeth that can be soaked through by the liquid potting material and thus can ensure that the liquid potting material reaches and bonds with all areas of the protective barrier and of the core teeth.

In a further possible embodiment, the bond-increasing material is made from a flexible sheet material, more particularly the bond-increasing material comprises at least one filament containing roving layer and/or a steel mesh.

The use of a flexible sheet material as the bond-increasing material facilitates the manufacturing process as the position of bond-increasing material can be adapted to the outer shape of the stator windings and the stator core teeth.

In optional embodiments, the bond-increasing material comprises at least one filament containing roving layer and/or a steel mesh.

The use of filament containing roving layers and/or of a steel mesh allows for a reliable permeation of the bond-increasing material with the liquid potting material during the potting process, while at the same time providing the later finished stator with improved crack-resistance properties.

The above mentioned optional step of enveloping the windings and the core teeth on at least one of the two axial sides and on a radial side with respect to the axis of rotation of the electric machine prior to the covering of the recessed space, enables an improved bonding of the protective barrier to the windings and core teeth and at the same time supports and guides the potting material during the potting process in contacting the windings and core teeth at these sides.

In a preferred embodiment, the stator is an inner stator and the windings and the core teeth are enveloped by the bond-increasing material on the two axial sides and on the radial outer side.

In a yet further possible embodiment of the inventive method, the protective barrier is provided in the form of a flexible sleeve, and the sleeve is pulled over the recessed space for covering the recessed space.

This allows a time-efficient covering of a circumferentially extending recessed space.

It is also possible that in an embodiment the sleeve is made from an elastic material and is pulled over the recessed space such that it covers the recessed space in a tensioned manner, in particular the sleeve is pulled over the recessed space by use of a sleeve widening mounting tool.

Covering the recessed space in a tensioned manner in which the sleeve presses radially inward against the edges of the recess space facilitates the potting process and, for example, in cases in which the sleeve seals the recessed space by use of an adhesive prior to the introduction of potting material, the pressing forces of the sleeve against the edges of the recessed space formed by the stator housing facilitates the distribution of the adhesive and thus the formation of a fluid-tight seal.

In a further possible embodiment of the inventive method, the sleeve is made from a heat shrinkable material and is heat-shrinked to tightly cover the recessed space prior to the introducing of the potting material.

This enables a reliable covering of the recessed space and in cases of a fluid-tight sealing of the recessed space prior to the introduction of potting material, facilitates the formation of a seal, for example by using an adhesive.

In a further possible embodiment, the circumference of the flexible sleeve is individually manufactured and customized to the outer dimensions of the stator housing prior to pulling the sleeve over the recessed space.

This individual and customized manufacturing step ensures a perfect fit between the sleeve and the stator housing and thus a reliable covering of the recessed space.

The initially stated objective is further achieved by the use of a water impermeable air-gap facing barrier of a stator as a potting material barrier structure according to the independent use claim 19.

The inventive solution suggests the use of a water impermeable air gap-facing protective barrier of a stator suitable for an electric machine of the type that comprises a stator, a rotor and an air gap in-between, in particular the use of an air gap-facing protective barrier of a stator according to one of the heretofore described embodiments, as a potting material barrier structure for defining a permanently bonded barrier for the potting material and for preventing the liquid potting material from coming into contact with a potting mould during the stator's manufacturing and potting process.

By using the part that itself forms the air gap-facing protective barrier of the later finished stator as a potting material barrier structure in the aforementioned manner, it is possible to efficiently manufacture a stator protected against the ingress of moisture from the air-gap. As the air gap-facing protective barrier prevents the liquid potting material from coming into contact with the potting mould, the potting mould can be re-used many times and such stators can be manufactured in an efficient manner.

In a further embodiment, the air-gap facing barrier is used for the manufacturing and potting of a stator according to one of the embodiments described heretofore.

Exemplary embodiments that advantageously combine aforementioned embodiments will now be described by making reference to the following figures:

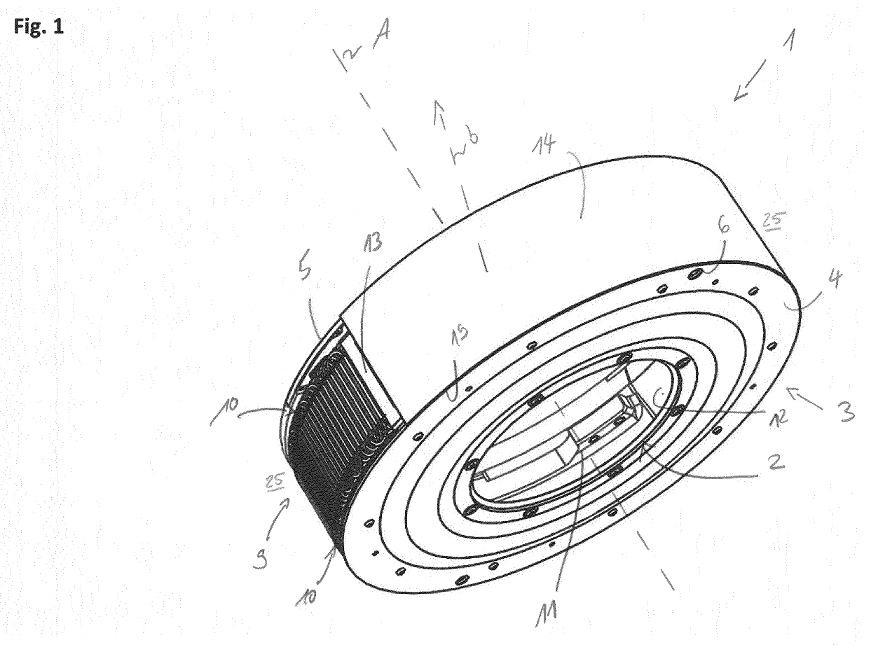

FIG. 1 shows an perspective schematic view of a stator according to an embodiment of the invention with an outer protective barrier and an underlying bond-increasing material partially cut away at the left side of the figure for illustrative purposes,

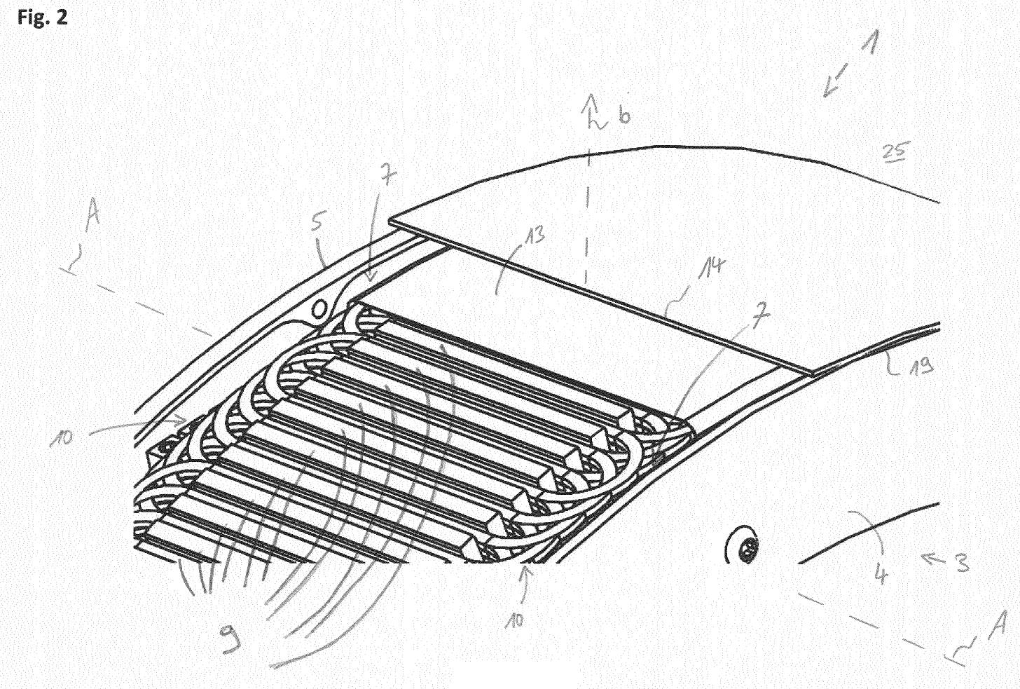

FIG. 2 shows a partial enlarged view of the lower left region of FIG. 1,

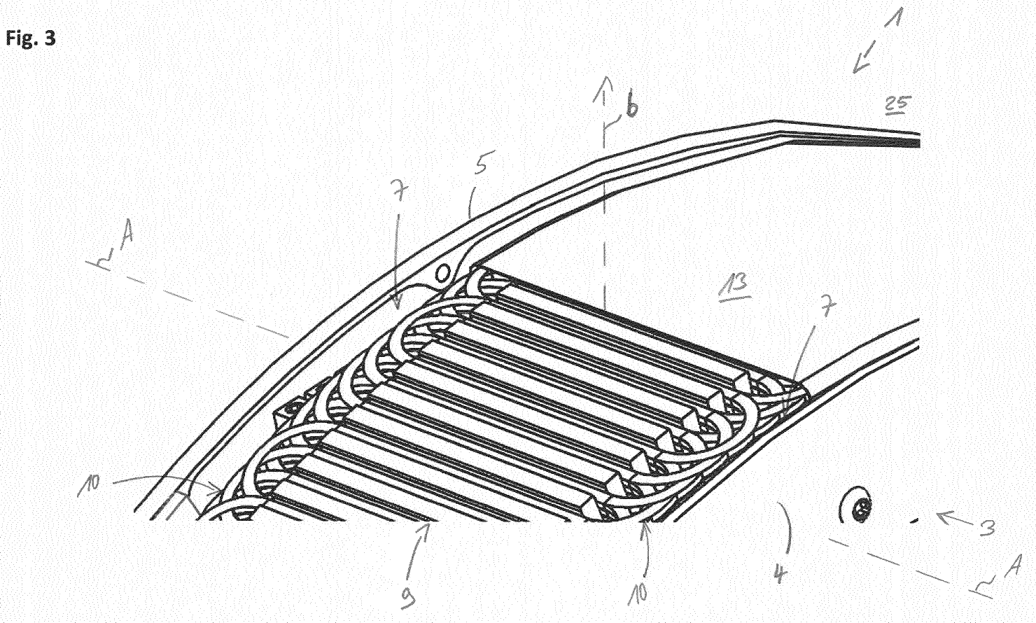

FIG. 3 shows a part of the stator of FIG. 1 with the protective barrier omitted and the bond-increasing material cut away in the radial direction,

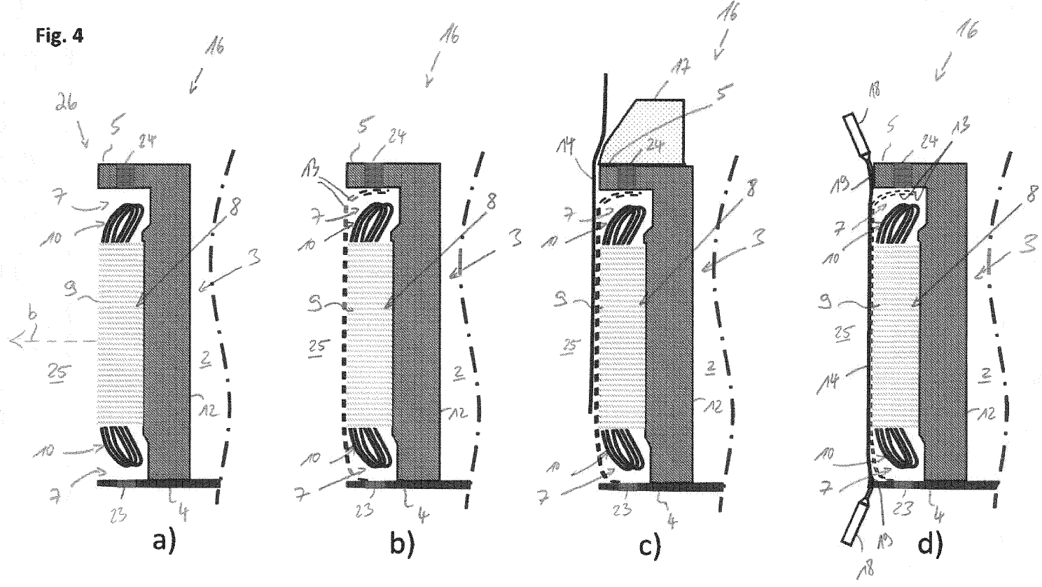

FIG. 4 shows schematic sectional illustrations of a part of a stator according to a further embodiment of the invention, the illustrations being cut in the radial direction during steps of the stator's manufacturing and potting process, and

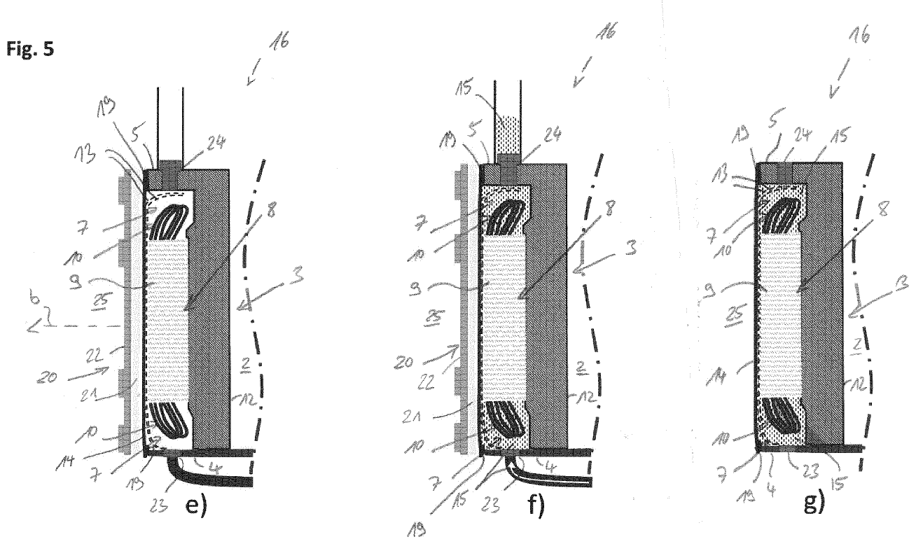

FIG. 5 shows further schematic illustrations following the steps of FIG. 4.

FIG. 1 shows an embodiment of stator 1 for an electric machine of the well-known type that comprises a stator, a rotor and an air gap in-between. More specifically, in the present embodiment, the stator is an inner stator for an outer rotor as often used in known ‘in-wheel motor’ applications for automobiles, such as disclosed in WO 2019/139545 A1.

The stator 1 has a substantially rotationally symmetrical shape around an axis A, which is also the axis of rotation of the electric machine, more specifically the axis of rotation of a rotor (not shown) that surrounds the stator 1 in the radial direction b, while forming a small air gap 25 in-between. The stator 1 has a central opening 2, for example for providing space for vehicle components (not shown), such as a brake systems and bearing systems.

In the present case, the radial outer side of the stator 1 is referred to as the air gap-facing side of the stator 1.

The stator 1 comprises a stator housing 3, which in this embodiment comprises two opposing axial outer walls 4, 5, that also serve as heatsinks in the present embodiment, that continuously extend, in this embodiment substantially parallel to each other, in the radial direction b and circumferentially around the axis A. In another, not depicted embodiment, the stator housing 3 can, for example, comprise only a single outer stator housing wall 4.

Between the two outer walls 4, 5, that in the present case contain sealable ports 6 at their radial outer regions for an efficient epoxy resin potting process, the stator housing 3 comprises a recessed space 7, which accommodates a stator core 8 having a plurality of core teeth 9, often in practice also referred to as the ‘blade-stack’, provided on the air gap-facing side in a circumferentially distributed and equidistant manner. On a radial inner side of the stator housing 3, a wall 12 extends in the axial direction between the outer walls 4, 5, wherein the recessed space 7 is surrounded by these walls 4, 5, 12.

In the non-depicted embodiment in which the stator housing 3 only comprises a single outer wall 4 at one axial side, for example another structure realizes the outer boundary function of the second outer wall 5 at the opposing axial side, wherein the recessed space 7 is then provided between the single outer wall 4 and said other structure.

In the embodiment of FIG. 1, electromagnetic windings 10 are arranged around the individual core teeth 9 in axial extending loops for generating together with the core teeth 9 electromagnetic fields which can interact with magnets of a rotor (not shown) in the known manner to drive the rotor during operation of the electric machine, which is formed by such a combination of stator and rotor.

In the present embodiment of FIG. 1, the radial extension of the two opposing circumferential outer walls 4, 5 is slightly larger than the radial extension of the circumferentially arranged core teeth 9.

On the radial inner side of the stator housing 3 that forms an outer wall 12 of the central opening 2, there are flanges 11 for mounting the stator 1 to a vehicle (not shown).

When regarded from the radial inner side in the radial direction b to the outermost air-gap 25 facing side of the stator 1, the arrangement of parts of the present stator 1, when regarded in the region of the recessed space 7, would be as follows: the stator housing 3, followed by the stator core 8 comprising the teeth 9 with the electromagnetic windings 10 arranged in a substantially axial direction around the teeth 9 at approximately the same radial position as the core teeth 9, followed by a bond-increasing mesh like material 13 enveloping the stator teeth 9 and windings 10 on their two axial facing sides and on the radial outer side, i.e. on the air-gap facing side, followed by the protective barrier 14.

The protective barrier 14 is water impermeable and located on the outermost air gap-facing side of the stator 1, that is, when regarded in the radial direction b.

In this embodiment, the protective barrier 14 has been made from an elastic and transparent thin polymeric sleeve made of water impermeable polyester foil, which had previously been provided with a roughened surface finish by a TCA (tri-chloric acid) treatment at its radial inner side, that is, at the side facing the stator housing 3 that is in contact with the circumferential and radial outer edges of the outer walls 4, 5 of the stator housing 3 and with the potting material 15 which bonds the protective barrier 14 to the bond-increasing mesh like material 13.

In another embodiment, the protective barrier 14 can be made from a heat-shrinkable polymer sheet material or from a stainless steel sheet material.

In this embodiment, the stator housing 3 is made from an aluminum alloy and has an adhesive bond increasing surface finish in the form of a roughed surface finish at surface areas that contact the protective barrier 14 and the potting material 15, which in this embodiment is a cured epoxy resin. Such a surface finish can for example be realized by an e-coating process, such as a KTL (‘Kathodische Tauchlackierung’”) process. Such adhesive bond-increasing surface finishes can also increase the thermal contact between an epoxy resin and the stator housing during the potting process.

In the present embodiment of FIG. 1, the bond-increasing mesh-like material 13 is a single ply of glass fiber roving provided between the air gap-facing side, that is the radial outer side, of the core teeth 9 and the protective barrier 14.

More specifically, in this embodiment, the bond-increasing material 13 envelopes in a C-shaped manner the core teeth 9 and windings 10 on both axial sides and on the outer radial side with respect to the axis A.

In another embodiment of a stator 16 which is depicted in FIG. 5g), two sheets/plies of glass fiber roving are wrapped in a C-shaped manner around the three sides of the core teeth 9 and windings 10 for an even better bonding of the protective barrier 14 to the core teeth 9 and windings 10.

In further embodiments, the aforementioned bond-increasing material can constitute one, two or more sheets/plies at least partly made from carbon fibers.

An aspect of the bond-increasing mesh-like material 13, in particular when realized by one or more glass fibre roving sheets, is the soaking of the potting material, in particular of epoxy resin, over the top surface of the stator teeth 9 during the potting process. Since the stator 1 is laminated, the top surface of the stator teeth 9 is porous and in time it would be prone to water ingress corroding the iron laminate. Having the potting material as a sort of impregnation layer reliably positioned between the protective barrier 14 and the stator teeth 9 is helpful to protect the stator teeth 9 in case the protective barrier 14 should be breached.

A manufacturing and potting process according to the present invention will be explained by making reference to FIGS. 4 and 5 that show manufacturing and potting steps for a stator 16 according to an embodiment of the present invention. The features of stator 16 that are similar to the features of stator 1 bear the same reference numbers. As indicated by the dash-dot-line, the FIGS. 4 and 5 illustrate the manufacturing and potting process by making reference to a little less than one cut half of the full stator. The non-depicted other cut half would be a mirror image.

As can be taken from the schematic illustration in FIG. 4a), an assembly 26 comprising the stator housing 3 accommodating in its recessed space 7 the stator core 8 with the stator teeth 9 and the electromagnetic windings 10 is provided. As can further be taken from this figure, the radial extension of the two opposing outer axial walls 4, 5, which is the extension direction to the left side in FIG. 4a), is approximately of the same length than the radial extension of the core teeth 9 in this direction.

In other, non-depicted, embodiments, the radial extension of the core teeth 9 can be shorter than the radial extension of the outer walls 4, 5. In yet a further, non-depicted embodiment, only a single outer wall 4 limits the recessed space 7 to an axial side, which would be the bottom side in the illustrations of FIGS. 4 to 5.

In a subsequent step as illustrated in FIG. 4b), two layers/plies of glass roving 13 are wrapped in a cross-sectional C-shaped manner around the air gap-facing radial outer side of the core teeth 9 and the windings 10, such that they envelop the core teeth 9 and windings 10 on the radial outer side and the two adjacent axial sides with respect to the axis A. Axis A is not illustrated in FIGS. 4 and 5, but would extend vertically from top to bottom in these figures in the area of the central opening 2.

In a next step as illustrated in FIG. 4c), the protective barrier 14, which here is made from a sleeve-shaped elastic polyester foil that had been roughed on its radial inner side, is pulled over the recessed space 7 by use of a sleeve widening tool 17, here in the form of a conically shaped tool. As the length of the circumference of the foil sleeve 14 has been individually manufactured and customized in a previous step to the outer dimensions of the stator housing 3, wherein it has further been selected to be slightly smaller than the outer circumference of the stator housing 3 at the radial outer sides of the outer walls 4, 5, the protective barrier sleeve 14 is in a neatly fitting and tensioned state and presses against its areas of contact to the outer walls 4, 5.

In embodiments in which the protective barrier sleeve 14 is made from a heat shrinkable material, the sleeve 14 is pulled over the recessed space and is then, via the application of heat, shrunk to tightly fit over the recessed space 7.

In a subsequent step as illustrated in FIG. 4d), the protective barrier sleeve 14 is glued by the use of an adhesive, for example by a glue 19 applied by a syringe 18, to the outer walls 4, 5 in a fluid-tight manner around the entire circumferential contact areas between the protective barrier 14 and outer walls 4, 5, such that the protective barrier 14 seals the recessed space 7 at the open air gap-facing side. The tensioned or stretched state of the elastic protective barrier sleeve 14, or the heat-shrinked state in embodiments using a heat shrinkable sleeve 14, helps to ensure the forming of a fluid-tight sealing due to the inherent and constant radially inward pressing of the protective barrier 14 against the outer walls 4, 5 as the glue 19 hardens and adheres the protective barrier 14 to the outer walls 4, 5.

In another, non-depicted embodiment of the inventive method, the adhesive is applied to the protective barrier 14 and/or the outer walls 4, 5 prior to the covering of the recessed space 7 by the protective barrier 14, that is, prior to the step of FIG. 4c).

In yet other, non depicted embodiments, it is also possible to, for example, select the properties of the elastic protective barrier sleeve 14 or the heat shrinkable protective barrier sleeve 14 in such a manner that the protective barrier 14 seals the recessed space 7 during the manufacturing and potting process in a fluid-tight manner, for example, by means of the protective barrier sleeve 14 alone, without the need of gluing the protective barrier 14 to the outer walls 4, 5 by the use of an adhesive, here the glue.

Afterwards, as illustrated in FIG. 5e), a potting mould 20 is provided around on the air gap-facing side of the stator 1 with a silicone lining 21 pressed by a clamping mould ring 22 against the protective barrier 14 and the walls 4, 5 of the stator housing 3.

Then, as depicted in FIG. 5f), the liquid potting material 15 (dotted areas in FIGS. 5f) and 5g)), is introduced into the still empty recessed space 7 through an axial inlet port 23 (previously herein referred to as a port 6) located in the outer wall 4, while at the same time a vacuum is applied via an upper outlet port 24 (previously herein referred to as a port 6) to the recessed space 7.

As the recessed space 7 had been sealed in a fluid-tight manner by the gluing of the protective barrier 14 to the outer walls 4, 5 of the stator housing 3 in the step of FIG. 4d), the protective barrier 14 prevents the liquid potting material 15 from coming into contact with parts of the potting mould 20. Thus, the protective barrier 14 is used as a potting material barrier structure that defines a boundary for the liquid potting material 15 at the air-gap facing side during the stator's manufacturing and potting process and is permanently bonded to the potting material.

The bond-increasing material 13, here in the form of the two plies of glass-roving material, serve as a sort of spacer and liquid guiding material enabling the liquid potting material 15 during the potting material introducing process to be soaked into the tight space between the protective barrier 14 and the core teeth 9.

This ensures that the potting material 15 reaches and fills all inner sections of the recessed space 7 and thus increases the crack resistance, moisture protection and strength of the final stator 1, 16.

After the recessed space 7 has been fully filled with the liquid potting material 15, the ports 23, 24 are sealed and the potting material 15 allowed to cure.

After the potting material 15 has cured, the stator 16 is demoulded from the potting mould 20, wherein the protective barrier 14 helps to ensure an easy demoulding as the potting material 15 did not come into contact with and still does not contact the potting mould 20. This also allows the re-use of the same potting mould 20 for subsequent potting procedures with little efforts.

The finished stator 16, as illustrated in step see FIG. 5g), or the stator 1 of FIG. 1 can be used in an electric machine, such as an ‘in-wheel” motor for an automobile, while the inner parts of the stator 1, 16 are protected from ingress of water and other materials coming from the air-gap side. Further, the stator 1, 16 has superior structural resistance and bonding properties between the protective layer 14, the potting material 15, the core teeth 9 and windings 10, while at the same time allowing a time- and cost efficient manufacturing.

1. A stator for an electric machine of a type that comprises a stator, a rotor and an air gap in-between, in particular an inner stator for an outer rotor motor, the stator comprising:
a stator core having a plurality of core teeth;
electromagnetic windings arranged around the plurality of core teeth;
a stator housing comprising a recessed space which is open at an air gap-facing side of the stator, the recessed space accommodating the stator core and the electromagnetic windings; and
a water impermeable protective barrier sealing the recessed space at the air gap-facing side in a fluid-tight manner, wherein
the water impermeable protective barrier, is permanently bonded to the electromagnetic windings and the plurality of core teeth by potting material provided in the recessed space.

2. The stator of claim 1, wherein a bond-increasing mesh-like material permeated by the potting material is provided between the plurality of core teeth and the water impermeable protective barrier, in particular the bond-increasing mesh-like material comprising a flexible sheet material, more particularly the bond-increasing mesh-like material comprises at least one filament comprising a roving layer and/or a steel mesh.

3. The stator of claim 2, wherein the at least one filament comprising the roving layer comprises at least one of glass fibers and carbon fibers.

4. The stator of claim 2, wherein the bond-increasing mesh-like material envelops the electromagnetic windings and the plurality of core teeth on at least one of two axial sides and on a radial side with respect to an axis of rotation of the electric machine.

5. The stator of claim 1, wherein the water impermeable protective barrier comprises a flexible sleeve and/or is at least partly transparent.

6. The stator of claim 1, wherein the water impermeable protective barrier comprises a polymer sheet material, in particular a heat shrinkable polymer sheet material and/or an elastic polymer sheet material, or comprises stainless steel sheet material.

7. The stator of claim 1, wherein the water impermeable protective barrier seals the recessed space at the air gap-facing side by other means than the potting material, in particular by an adhesive.

8. The stator of claim 1, wherein the water impermeable protective barrier contacts the stator housing at opposing axial outer walls of the stator housing, the recessed space being disposed between the outer walls, and the water impermeable protective barrier joined to the outer walls in a fluid-tight manner.

9. The stator of claim 1, wherein the water impermeable protective barrier at least partly comprises an adhesive bond-increasing surface finish, in particular a roughened surface finish, on a side facing the stator housing and/or the stator housing at least partly comprises an adhesive bond-increasing surface finish, in particular a roughened surface finish, on a side facing water impermeable the water impermeable protective barrier.

10. The stator of claim 8, wherein the electromagnetic windings and the plurality of core teeth are accommodated fully within the recessed space, such that the outer walls of the stator housing are of about equal height or higher than the plurality of core teeth and electromagnetic in a radial direction with respect to an axis of rotation of the electric machine.

11. (canceled)

12. A method of manufacturing a stator for an electric machine of a type that comprises a stator, a rotor and an air gap in-between, in particular a method of manufacturing an inner stator for an outer rotor motor, the method comprising:
providing an assembly comprising a stator housing comprising in a recessed space a stator core having core teeth and electromagnetic windings arranged around the core teeth, wherein the recessed space is open at an air gap-facing side of the stator; and
providing a water impermeable protective barrier covering the recessed space at an open side; and
permanently bonding the water impermeable protective barrier to the electromagnetic windings and the core teeth by introducing liquid potting material into the covered recessed space.

13. The method of claim 12, further comprising sealing the recessed space at the open side with the water impermeable protective barrier in a fluid-tight manner using an adhesive; prior to introducing the potting material.

14. The method of claim 12, further comprising covering the core teeth with a bond-increasing mesh-like material, in particular with flexible bond-increasing mesh-like sheet material, prior to the covering of the recessed space, in particular enveloping the electromagnetic windings and the core teeth on at least one of two axial sides and on a radial side with respect to an axis of rotation of the electric machine prior to the covering of the recessed space.

15. The method of claim 12, wherein the water impermeable protective barrier comprises a flexible sleeve, wherein the flexible sleeve is pulled over the recessed space for covering the recessed space.

16. The method of claim 15, wherein the flexible sleeve comprises an elastic material and is pulled over the recessed space such that it covers the recessed space in a tensioned manner, in particular the flexible sleeve is pulled over the recessed space by use of a sleeve widening mounting tool.

17. The method of claim 15, wherein the flexible sleeve comprises a heat shrinkable material and is heat-shrinked to tightly cover the recessed space prior to the introducing of the potting material.

18. The method of claim 15, wherein a circumference of the flexible sleeve is individually manufactured and customized to outer dimensions of the stator housing prior to pulling the flexible sleeve over the recessed space.

19. A method for using a water impermeable air gap-facing protective barrier of a stator suitable for an electric machine of a type that comprises a stator, a rotor and an air gap in-between, the method comprising:
using an air gap-facing protective barrier of a stator as a potting material barrier structure for defining a permanently bonded barrier for the potting material; and
using the air gap-facing protective barrier of the stator to prevent the potting material from coming into contact with a potting mold during a manufacturing and potting process for the stator.
